(19) United States
(12) Patent Application Publication
(10) Pub. No.: US 2009/0255875 A1
(43) Pub. Date: Oct. 15, 2009

(54) IMPROVEMENTS IN REGENERATION OF SULFUR SORBENTS

(76) Inventors: Peter D. Unger, Morristown, NJ (US); Ronald P. Rohrbach, Flemington, NJ (US); Daniel E. Bause, Flanders, NJ (US); Scott J. Tabb, Huntersville, NC (US)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/421,861

(22) Filed: Apr. 10, 2009

Related U.S. Application Data
(60) Provisional application No. 61/044,331, filed on Apr. 11, 2008.

(51) Int. Cl. B01D 29/62; B01D 15/08; B01D 35/18; B01D 35/02

(52) U.S. Cl. 210/670; 210/184; 210/106

(57) ABSTRACT

Exemplary embodiments of the present invention relate to a fuel filter, system, and method for reduction, manipulation and/or distribution of sulfur containing compounds in a fuel stream of an internal combustion engine. In one exemplary embodiment of the present invention, a method of removing sulfur containing compounds from a fuel stream of an internal combustion engine is provided. The method includes removing sulfur containing compounds from a fuel stream by passing fuel through a fuel filter capable of removing sulfur containing compounds. The method also includes storing the sulfur containing compounds in the fuel filter and releasing portions of the stored sulfur containing compounds into the fuel stream at predetermined intervals of a regeneration cycle of an emission control device.

### CROSS-REFERENCE TO RELATED APPLICATIONS

This application claims the benefit of U.S. Provisional Patent Application Ser. No. 61/044,331, filed on Apr. 11, 2008, which is related to U.S. Published Patent Application No. 2005/0236334, to Rohrbach et al., filed Mar. 15, 2005, the contents of which are incorporated herein by reference thereto.

### FIELD OF THE INVENTION

Exemplary embodiments of the present invention relate to a fuel filter, system, and method for reduction, manipulation and/or distribution of sulfur containing compounds in a fuel stream of an internal combustion engine. More particularly, exemplary embodiments of the present invention provide enhanced ability of post combustion emission control devices to reduce nitrogen oxide emissions from internal combustion engines, especially motor vehicle engines, by reducing the amount of sulfur to the emission control devices.

### BACKGROUND

Nitrogen oxide or ‘NOx’ adsorbers are often used to remove nitrogen oxides from exhaust streams of both mobile and stationary internal combustion engines. However, the efficiency of such NOx adsorbers is reduced in the presence of sulfur containing compounds. Such sulfur containing compounds, especially sulfur containing aromatic compounds, ‘poison’ or react ‘irreversibly’ with the catalysts of NOx adsorbers. NOx adsorbers having contaminated catalysts have reduced efficiency. As a result, the presence of sulfur containing compounds in fuels used in internal combustion engines can have a deleterious effect upon exhaust emissions, especially with respect to nitrogen oxide emissions. This problem is of particular concern in motor vehicles and stationary systems employing diesel engines.

The catalysts in NOx adsorbers typically undergo regenerative processes designed to extend the life expectancy of the catalyst/NOx adsorber. A first type of regenerative process is designed to drive off the NOx in the form of nitrogen from the NOx adsorber. In a second type of regenerative process, contaminants such as sulfur containing compounds are released or removed. The later process is sometimes referred to as desulfation and typically occurs at higher temperatures than the NOx regeneration process. Repeated exposure to such high temperatures can adversely affect catalyst life expectancy.

The concentration of sulfur containing compounds present in the fuel stream directly impacts how often an NOx adsorber must undergo desulfation. The higher the concentration, the more often the catalyst of an NOx adsorber must undergo desulfation. Similarly, an NOx adsorber will have a shorter life expectancy the more often it undergoes desulfation.

It would thus be advantageous to provide a fuel filter, system and method capable of minimizing the adverse effects of sulfur contaminants on the NOx adsorber.

There are devices that remove sulfur-containing fuels from internal combustion engine fuel streams. For example, U.S. Patent Publication No. U.S. 2002/0028505 A1, the contents of which are incorporated herein by reference thereto discloses a desulfation apparatus to be mounted in automobiles, which is arranged between a fuel tank and an injector of an engine, the apparatus comprising a combination of a sulfur-containing compound adsorbent for adsorbing and concentrating the sulfur-containing compound and a sulfur-containing compound oxidizing agent or oxidation catalyst for oxidizing the adsorbed sulfur-containing compound, the apparatus further comprising a means for recovering and removing the resulting sulfur-containing oxide.

However, there remains a need for devices, especially fuel filters that reduce the amount of sulfur containing compounds in an internal combustion fuel stream to a desirable concentration, especially to concentrations of 3 ppm or less.

It would also be advantageous if such a fuel filter could be regenerated, that is, could distribute some or all of the stored sulfur containing compounds in order to extend the life cycle or capacity of the fuel filter. It would be particularly advantageous if such regeneration could occur without imposing any additional deleterious effects upon the NOx adsorber or upon engine exhaust emissions. It would also be desirable if such a fuel filter could thus extend the life cycle of NOx adsorbers by reducing the frequency of desulfation.

### SUMMARY OF THE INVENTION

Exemplary embodiments of the present invention improve on prior engine exhaust treatment systems by providing methods, systems and devices for removal of sulfur containing compounds from a fuel stream and processing said removed sulfur containing compounds with little to no appreciable degradation of the exhaust treatment system. In one exemplary embodiment, this is achieved through the use of a filter for removal of sulfur containing compounds from a fuel stream and regeneration of the filter during regeneration of at least a portion of the exhaust treatment system. In another exemplary embodiment, the regeneration of the fuel filter, and hence release of sulfur containing compounds, is synchronized with the regeneration of the exhaust treatment system. In another exemplary embodiment the regeneration of the fuel filter is based upon volume of fluid flow therethrough.

In one exemplary embodiment of the present invention, a method of removing sulfur containing compounds from a fuel stream of an internal combustion engine is provided. The method includes removing sulfur containing compounds from a fuel stream by passing fuel through a fuel filter capable of removing sulfur containing compounds. The method also includes storing the sulfur containing compounds in the fuel filter and releasing portions of the stored sulfur containing compounds into the fuel stream at predetermined intervals of a regeneration cycle of an emission control device.

In another exemplary embodiment of the present invention, a system for maintaining optimal performance of an emission control device is provided. The system includes a fuel filter in fluid communication with a fuel line of an internal combustion engine. The fuel filter is configured to adsorb sulfur containing compounds traveling through the fuel line. The system also includes an emission control device in fluid communication with an exhaust fluid flow from the internal combustion engine. The system further includes a control device for simultaneously causing regular discharge of accumulated sulfur within the fuel filter and regeneration of the emission control device based upon a volume of fuel flow through the fuel line.

In yet another exemplary embodiment of the present invention, a fuel filter for an internal combustion engine is provided. The fuel filter includes an adsorbent element for capturing sulfur containing compounds flowing through the fuel filter and a heating element configured to heat the fuel filter to cause release of captured sulfur containing compounds. The heating element is configured to heat the fuel filter when a predetermined bed volume interval of fuel flows through the fuel filter.

The above-described and other features and advantages of the present invention will be appreciated and understood by those skilled in the art from the following detailed description, drawings, and appended claims.

### BRIEF DESCRIPTION OF THE DRAWINGS

Other objects, features, advantages and details of exemplary embodiments of the present invention appear, by way of example only, in the following detailed description of preferred embodiments of the invention, the detailed description referring to the drawings in which:

FIG. 1 illustrates a flow diagram of an exemplary embodiment of the present invention;

FIG. 2 illustrates an effluent sulfur chart according to exemplary embodiments of the present invention;

FIG. 3 illustrates the chart of FIG. 2 in a different effluent sulfur scale according to exemplary embodiments of the present invention; and

FIG. 4 illustrates a processed fuel sulfur chart according to exemplary embodiments of the present invention.

### DESCRIPTION OF THE EXEMPLARY EMBODIMENTS

This application is related to the following U.S. patent application Ser. No., 11/081,796, filed Mar. 15, 2005 and Ser. No. 11/674,913, filed Feb. 14, 2007, the contents each of which are incorporated herein by reference thereto.

As stated above, exemplary embodiments of the present invention improve on prior engine exhaust treatment systems by providing methods, systems and devices for removal of sulfur containing compounds from a fuel stream. The removed compounds are subsequently processed with little to no appreciable degradation of the exhaust treatment system. In one exemplary embodiment, this is achieved through the removal of sulfur containing compounds from a fuel stream through the use of a filter and regeneration of the filter during regeneration of at least a portion of the exhaust treatment system. Regeneration of the fuel filter, and hence release of sulfur containing compounds, is synchronized with the regeneration of the exhaust treatment system and based upon volume fluid flow of fuel through the filter.

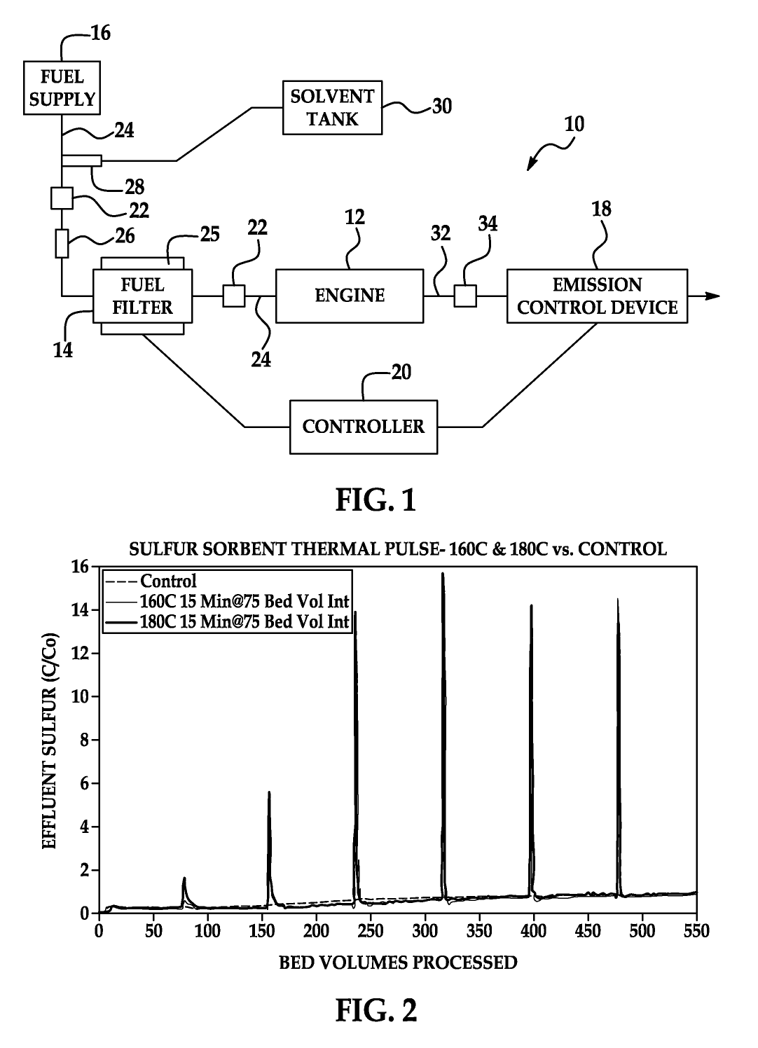

In one exemplary embodiment of the present invention, referring to FIG. 1, an emission control system 10 for an engine 12 is provided. The system includes a fuel filter 14, configured to filter sulfur containing compounds from fuel traveling from a fuel supply 16 to engine 12. The system also includes an emission control device 18 for removal of harmful contaminants from the emissions exiting the engine 12. Fuel filter 14 and emission control device 18 are controlled through a controller 20. The system 10 also further includes one or more sensors 22 for monitoring the volume or the volume flow rate of fuel passing through fuel filter 14.

In one exemplary embodiment, operation of the emission control system 10 includes filtering sulfur containing compounds from a fuel line 24 of vehicle engine 12 through fuel filter 14. Based upon the volume of fluid flow through the fuel line 24, fuel filter 14 or both, the fuel filter 14 is regenerated to purge adsorbed sulfur containing compounds. Regeneration of the fuel filter 14 is performed during regeneration of emission control device 18, such as during DeNOx or DeSOx function. Regeneration of the fuel filter 14 and the emission control device 18 may be initiated by controller 20, based upon the volume and/or the rate of fuel flow or other parameters or a combination of parameters sensed by the one or more sensors 22.

The forgoing is a general description of certain non-limiting embodiments of the present invention. The following provides a more detailed description of exemplary features of the exhaust system of the present invention.

As mentioned above, exemplary embodiments of the present invention include a fuel filter or fuel filter assembly to remove sulfur containing compounds from a fuel line of the engine. The fuel filter 14 may comprise one or more separate filters or an integrated filter. Accordingly, the fuel filter 14 may be configured for removing contaminants other than sulfur containing compounds from the fuel, particularly contaminants capable of causing harm to an engine and/or emission control device.

In one exemplary embodiment, the fuel filter 14 functions, at least in part, through adsorption wherein contaminants within a fluid flow accumulate on a surface of the filter. This accumulation is the result of bonding (e.g., ionic, covalent, metallic or otherwise) between the contaminants within the fluid flow and an internal surface of the filter. In such configuration, it is contemplated that the filter, or this portion of the filter, may be regenerated (e.g., through heating or otherwise) or replaced as needed. Adsorption of compounds is particularly advantageous in the removal of sulfur containing compounds from the fuel flow. However, it should be appreciated that other compounds may also be adsorbed with the fuel filter and should not be limited to the examples described herein.

In another exemplary embodiment, it is also contemplated that the fuel filter functions, at least in part, through screening out contaminants within the fuel flow. This is particularly advantageous for the removal of foreign matter from the fluid flow. In this configuration, it is contemplated that the filter, or this portion of the fuel filter, may be cleaned to remove the accumulated foreign matter or it may be replaced. Examples of material that may be removed through this filtration process includes particulate matter or otherwise. However, it should be appreciated that the fuel filter may be configured to remove other undesired materials as well such as water or otherwise.

In one exemplary embodiment, the fuel filter 14 is further configured for regeneration in order to release all or a portion of contaminates adsorbed or otherwise captured by the filter. The releasable contaminants may comprise impurities such as sulfur, particulate matter or otherwise. In such configurations, it is contemplated that the filter may be configured to be heated to cause the release of these contaminants.

Regeneration of the fuel filter 14 may comprise complete regeneration where the entire adsorbent is heated to release sulfur containing compounds therefrom. Regeneration may also comprise partial regeneration where only a portion of the adsorbent is heated to release sulfur containing compounds. This partial release may be referred to as partial or zonal stripping such as trailing end stripping, leading end stripping, middle stripping or otherwise.

During regeneration, the filter 14 is heated to a steady state temperature suitable to cause the release of at least some, or all, of the material adsorbed or captured by the filters by the fuel filter in accordance with one exemplary embodiment. For example, the filter may be heated to a steady state temperature of about 140° C. or greater, about 160° C. or greater, about 180° C. or greater, about 200° C. or greater or otherwise. Accordingly, the heater may be heated to a steady state range of about 140° C. to about 200° C. or to a range of about 160° C. to about 180° C., or otherwise.

During regeneration, it is contemplated that heating of the filter includes a ramp-up period, a steady state period and a ramp-down period. The ramp-up period comprises the period in which the temperature of the fuel filter is continuously increased until a desired temperature is reached. The fuel filter then undergoes a steady-state temperature condition where the temperature of the fuel filter remains substantially constant. After the steady-state period, the application of heat is decreased, or removed, thereby allowing the filter to enter the ramp-down condition where the temperature of the filter is reduced.

In one exemplary embodiment, referring to FIG. 1, fuel filter 14 is heated through a heating device 25 attached or integrated with the fuel filter. The heating device includes one or more heating elements located on or in thermal communication with the fuel filter 14 and optionally the adsorption portion of the fuel filter 14. The heating element applies heat to the filter causing the filter to enter the ramp-up period until a steady state temperature is reached. Upon completion of heating, no additional heat is added to the fuel filter thereby allowing the fuel filter to return to a normal or lower operating temperature.

Alternatively, in another exemplary embodiment, again referring to FIG. 1, the fuel filter 14 may be heated through a fuel heating device 26 adapted to indirectly heat the fuel filter through heated fuel. For example, it is contemplated that the fuel heating device may comprise a resistant heater, or the like, located in the fuel stream and up stream from the fuel filter. As fuel passes by or along the resistant heater, the fuel is heated to a suitable temperature, such as at or below a boiling point of the fuel or otherwise. The heated fuel then, in turn, heats the fuel filter. As should be appreciated, in this embodiment the fuel filter may under go the same heating pattern as with the previous exemplary embodiment (e.g., ramp-up, steady state and ramp-down period).

With respect to the second exemplary embodiment, a fuel line or filter may include an injector port 28 for receiving a solvent from a solvent tank 30 or otherwise, for releasing, or aiding in the release of, sulfur containing compounds from the filter. The application of solvent may be used alone or in combination with the fuel heating device, fuel filter heating device or both.

In still other exemplary embodiments, it is contemplated that the fuel filter is heated through one or a combination of one or more fuel filter heating devices, fuel heaters and solvent applications. It is also contemplated that other heating configurations may be used as well.

With any of the fuel heating systems, it is contemplated that the time period of steady state heating of the fuel filter may be based upon different factors. In one exemplary embodiment, the steady state heating time period of the fuel filter is based upon a volume of fuel flowing through the filter. This may be further based upon a total volume of fuel flowing through the fuel filter, per regeneration cycle or otherwise. Also, this may be based upon the volume flow rate of fuel flowing through the fuel filter. However, in another exemplary embodiment the steady state heating time period is based upon the efficiency of the fuel filter to remove contaminants, a predetermined time period, the steady state temperature of the fuel filter, combinations thereof or otherwise.

Steady state heating of the fuel filter occurs for a suitable time period to allow for partial or total removal of contaminants from the fuel filter. In one exemplary configuration, the fuel filter is heated to a steady state temperature for at least about 10 minutes, 15 minutes, 20 minutes or otherwise. It is also contemplated that steady state heating may occur between about 10 to 20 minutes, between about 12.5 to 17.5 minutes, at about 15 minutes or otherwise.

Intervals between regeneration (or heating) of the fuel filter 14 may also be based upon different factors including time period, efficiency of the fuel filter to remove contaminants, steady state temperature of the fuel filter, combinations thereof or otherwise. However, in one exemplary configuration, the intervals between regeneration of the fuel filter is based upon volume flow of fuel through the fuel filter. In this exemplary configuration, the maximum contaminant level of the fuel filter can be decreased or optimized to further reduce the necessary steady state time for regeneration.

Accordingly, in one exemplary embodiment, the intervals between regeneration or heating of the fuel filter 14 is based upon volume of fuel flowing through the fuel filter. The period in which regeneration or heating occurs is based upon bed volume flowing through the filter. The bed volume is the volume capacity of the fuel filter, where 1 bed volume is equal to the volume capacity of the fuel filter. In exemplary embodiments, intervals between regeneration or heating occurs every 75 bed volume load interval, 150 bed volume load interval, 250 bed volume load interval, or otherwise, of fuel flowing through the fuel filter. In another exemplary embodiment, the interval between regeneration is between about every 50 to 300 bed volumes, 75 to 250 bed volumes, 150 to 250 bed volumes, or otherwise, of fuel flowing through the fuel filter.

Examples of suitable filters that may be used with the present invention can be found in commonly owned US Publication number 2005/0236334, to Rohrbach et al., the contents of which are hereby incorporated by reference for all purposes. These exemplary filters include a guard bed and column configured for adsorption of sulfur containing compounds. These filters are also configured for regeneration. Other suitable fuel filters are contemplated as well, including fuel filter capable of sulfur adsorption and regeneration.

One specific filter that may be used with an exemplary embodiment of the present invention includes an inorganic oxide sorbent with ultra low sulfur diesel (ULSD) having a sulfur content of 7.4 parts per million by weight.

Exemplary embodiments of the present invention can be used with internal combustion engines 12 employed in both stationary systems and motor vehicles. Illustrative examples of stationary systems include generators and power plants. Illustrative examples of motor vehicles include cars, trucks, boats, personal water craft, semi-trucks, construction devices such as bulldozers and cranes, small engine devices such as lawn mowers and tractors, and the like, wherein the sulfur removing fuel filter is part of an on-board system. An exemplary embodiment is a vehicular application wherein the sulfur removing filter is part of an emission control system wherein the filter releases captured sulfur containing compounds into the fuel stream during a regeneration process of a NOx adsorber. The regeneration of the NOx adsorber is conducted in accordance with technologies known to those skilled in the related arts.

Suitable internal combustion engines may be powered by any suitable organic fuel. In one exemplary embodiment, the fuel being treated by the emission control system comprises gasoline or diesel fuel. In another exemplary embodiment, the fuel being treated comprises a diesel fuel.

The sulfur containing compounds removed by the disclosed fuel filter may, in general, be any sulfur containing compound normally found in fuels intended for use in internal combustion engines. In one exemplary embodiment, the sulfur- containing compound removed by the disclosed filter will be a sulfur containing aromatic compound. Illustrative sulfur containing compounds removed by the disclosed fuel filter include benzothiophene, dibenzothiophene, and derivatives thereof. The disclosed fuel filters may remove one or more of such compounds from a fuel stream.

The fuel filters and methods described herein may be used with commercially available fuels, either ‘high’ sulfur fuels or ‘low’ sulfur fuels. In one embodiment, unfiltered fuel streams may comprise sulfur concentrations of from about 6 ppm to 500 ppm. In another embodiment, the filters and methods described herein may be used with unfiltered fuel streams having sulfur concentrations of from about 15 ppm or less. In one exemplary embodiment, the filters and methods described herein may be used with unfiltered fuel streams having sulfur concentrations of from about 9 ppm or less. In one embodiment, the disclosed filters and method may be used with unfiltered fuel streams having sulfur concentrations of from about 6 ppm to about 15 ppm.

In one embodiment, the disclosed method will result in filtered fuel streams having a reduced concentration of sulfur; especially sulfur concentrations of 3 ppm or less.

Exemplary embodiments of the present invention also include or contemplate an emission control devices 18. The emission control device 18 is in fluid communication with the engine 12 and designed to receive exhaust gas, and emissions therefrom, based upon an after product of burning fuel from the fuel exiting the fuel filter.

The emission control device 18 may comprise a stand alone component or may comprise an entire emission control system or even a component thereof. In any regards, the emission control device 18 is configured to remove or convert emissions from an exhaust flow from an engine. In one exemplary embodiment, the emission control device 18 comprises, or otherwise includes, a device configured for converting harmful emission gas into less harmful and more acceptable gas. For example, the emission control device 18 may comprise a nitrogen oxide or NOx adsorber used to remove nitrogen oxides from the exhaust streams. In one exemplary embodiment, the emission control device 18 comprises a Lean NOx Trap or LNT.

The emission control device 18 is configured for regeneration to remove build up of filtered or adsorbed contaminates from the exhaust gas. For example, the emission control device 18 may perform a deNOx or deSOx function to remove buildup of nitrogen oxide and/or sulfur oxide from the adsorbers of the emission control device. As previously mentioned, contaminants, particularly sulfur, have a degenerative effect on the emission control device, particularly the adsorbers.

In one embodiment, regeneration of the emission control device 18 comprises elevating the temperature of the emission control device 18 to a suitable temperature to cause deNOx and/or deSOx of the device. It should be appreciated that the necessary temperature for causing deNOx of the emission control device may be different from the temperature necessary for causing deSOx of the emission control device. Typically, the temperature for causing deSOx is higher than the necessary temperature for causing deNOx.

In one exemplary embodiment, regeneration of the emission control device coincides, at least in part, with regeneration of the fuel filter. Accordingly, regeneration of the emission control device may be synchronized with regeneration of the fuel filter. For example, it is contemplated that regeneration of the fuel filter occurs every regeneration cycle of the emission control device, every other regeneration cycle of the emission control device, every third regeneration cycle of the emission control device, every deSOx regeneration of the emission control device or otherwise. In any regards, it is contemplated the regeneration of the fuel filter and emission control device are synchronized to some extent.

Accordingly, in one exemplary embodiment, it is contemplated that intervals between regeneration of the emission control device are based upon volume flow through the fuel filter 14. In this exemplary embodiment, the maximum contaminant level of the fuel filter 14 can be decreased to further reduce the necessary steady state time for regeneration of both the fuel filter and the emission control device 18 thereby reducing the time in which the emission control device is subjected to necessary temperatures for causing deSOx of the device.

As mentioned above, the intervals between regeneration or heating of the emission control device may be based upon volume of fuel flowing through the fuel filter. The intervals between regeneration of the emission control device may include any of the intervals of regeneration of the fuel filter. For example, the period between intervals of regeneration of the emission control device may be based upon bed volume flowing through the fuel filter. In one exemplary embodiment, regeneration of the emission control device occurs every 75 bed volume load interval, 150 bed volume load interval, 250 bed volume load interval, or otherwise, flowing through the fuel filter. In another exemplary embodiment the interval between regeneration is between about every 50 to 300 bed volumes, 75 to 250 bed volumes, 150 to 250 bed volumes, or otherwise.

Exemplary embodiments of the present invention also contemplate the use of one or more sensors 22 for monitoring characteristics of fuel flow through the fluid line 24, exhaust flow or both. Such sensors are particularly advantageous in providing information relating contaminants in the fuel or exhaust flow as well as other characteristics such as temperature of fluid flow, volume or volume flow rate of fluid flow, pressure or otherwise. The sensors may be stand alone sensors or may be incorporated with one or more components (e.g., fuel supply, fuel line, fuel filter, engine, exhaust conduit 32, emission control device or otherwise).

In one exemplary embodiment, one or more fuel sensors 22 may be placed before and/or after the fuel filter 14 to monitor a volume or volume flow rate of fuel traveling into, out of or through the fuel filter. Such information can indicate when regeneration of the fuel filter and/or emission control device should take place. In another exemplary embodiment, one or more exhaust sensors 34 may be placed between the engine 12 and emission control device 18 to monitor a volume or volume flow rate flowing through a fluidly connecting conduit. It is within the scope of the present invention that regeneration of the fuel filter and/or emission control device may alternatively, or in addition to sensors of the fuel line, be based upon the fluid flow through the conduit.

Exemplary embodiments of the present invention also contemplated the use of controllers to control one or more components of the emission control system. In one exemplary embodiment, controller 20 may be used to control functions of the fuel filter 14, the emission control device 18, both the fuel filter 14 and emission control device 18, or otherwise. In one embodiment, the controller is configured to communicate with the one or more sensors for receiving information pertaining to the fuel flow and/or exhaust flow. Such information may be used to determine function of the fuel filter and/or emission control device, particularly timing for regeneration. Still further, the controller may be used to control functions of heating device 25, fuel heating device 26, solvent injector port 28 or any other component of, or associated with, the emission control system.

In one exemplary embodiment, the controller is in communication with one or more sensors located along or in communication with the fluid line or fuel filter. The one or more sensors are configured to monitor the volume of fuel flowing through the filter or the volume flow rate of fuel flowing through the filter, or otherwise. Information pertaining to the fuel flow through the fuel line or filter is transmitted to the controller. Based upon information generated by the sensors, the controller 20 causes substantially synchronized periodic regeneration of both the fuel filter and emission control device.

Referring to FIGS. 2 through 4, regeneration results of exemplary embodiments of the present invention are shown. The results are shown in graphical form and depict regeneration of exemplary embodiments of emission control devices including release of sulfur at select intervals of an operation cycle of the emission control system 10 or total processed sulfur through the emission control system.

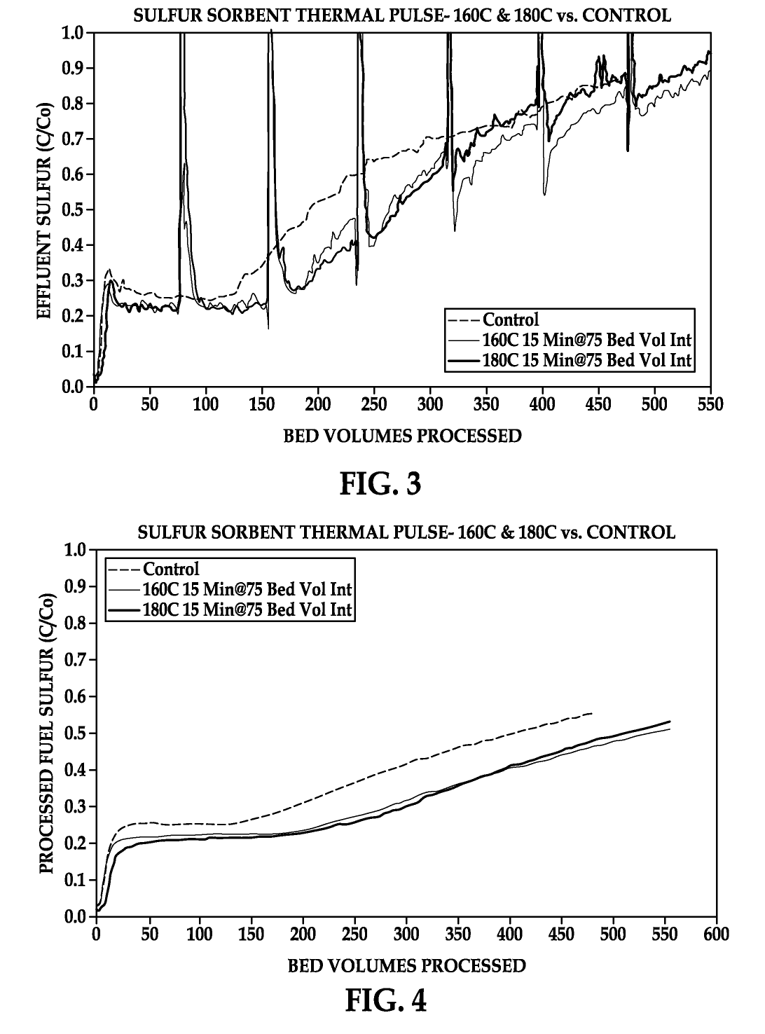

With reference to FIGS. 2 and 3, results from an exemplary embodiment of an emission control system 10 are shown, albeit in different scales. In this embodiment, effluent sulfur discharged by the fuel filter during regeneration is compared to bed volumes processed through the fuel filter, wherein C/Co is defined as the concentration of the processed fuel divided by the concentration of sulfur in the unprocessed fuel. The results depict regeneration of a fuel filter approximately every 75 bed volume intervals. The graph depicts a first test run comprising a control group, a second test comprising regeneration of a fuel filter every 75 bed volumes with steady state heating for 15 minutes at 160° C. and a third test comprising regeneration of a fuel filter every 75 bed volumes with steady state heating for 15 minutes at 180° C. As shown in the graph, regeneration of the fuel filter at 180° C. temporarily results in a higher effluent sulfur value during the heating process. In other words, higher temperature used in the regeneration of the fuel filter provided for greater release of sulfur from the fuel filter during the first five regenerations.

With reference to FIG. 4, results from an exemplary embodiment of an emission control system 10 are shown. In this embodiment, total processed sulfur by the emission control device 18 is shown as compared to bed volumes processed through the fuel filter 14. The graph depicts a first test run comprising a control group, a second test comprising total processed sulfur by the emission control device with a regeneration of a fuel filter every 75 bed volumes and with steady state heating for 15 minutes at 160° C. and a third test comprising total processed sulfur by the emission control device with a regeneration of a fuel filter every 75 bed volumes and with steady state heating for 15 minutes at 180° C. This graph depicts the total amount of sulfur passing through the emission control device from the fuel filter, during regeneration of the fuel filter. It should be noted that due to synchronized regeneration of the fuel filter and emission control device, a substantial majority of the sulfur being released from the fuel filter flows through the emission control device. Accordingly, the released sulfur is substantially invisible to the emission control device and accordingly does not foul the emission control device.

The regeneration cycle of exemplary fuel filters shown in FIGS. 2-4 may be synchronized with a regeneration cycle of an emission control device, as described herein. Accordingly, it is contemplated that release of sulfur from the fuel filters may be performed during regeneration of the emission control device and more particularly during a deNOx or deSOx event. This is particularly advantageous as the high temperature as a result of the deNOx or deSOx event will substantially limit or prevent adsorption of the sulfur onto the emission control device further preventing the same from the damaging effects therefrom.

With reference to FIG. 1, at least one exemplary embodiment of the present invention provides a method of removing a sulfur containing compound from a fuel stream of an internal combustion engine. The method includes fluidly coupling a fuel filter with fuel supply and an engine through placement of a fuel filter within a fuel filter line. The fuel filter stores sulfur containing compounds from within the fuel through an adsorbent material. The fuel filter is configured to release portions of the fuel filter into the fuel stream at predetermined intervals of a regeneration cycle of the fuel filter and/or an emission control device.

The method also includes fluidly coupling an emission control device to an exhaust component of an engine for receiving and treating exhaust generated through burning of fuel traveling through the fuel filter. The emission control device is configured for regeneration thereby causing deNOx and/or deSOx. One or more sensors are placed along the fuel line and/or exhaust for monitoring volume fluid flow through the fuel line or volume flow through an exhaust pipe or otherwise.

The method further comprises synchronized regeneration of the fuel filter and the emission control device to cause the captured sulfur containing compounds within the fuel filter to be released into the fuel stream and travel through the emission control device during elevated temperatures of the same. The passing of sulfur containing compounds through the emission control device at these elevated temperatures prevents adsorption of the compounds into the emission control device further preventing the same from damage.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of removing a sulfur containing compound from a fuel stream of an internal combustion engine, comprising:
filtering sulfur containing compounds from the fuel stream by passing the fuel stream through a fuel filter configured to filter sulfur containing compounds from the fuel stream, the fuel filter having an inlet and outlet;
storing filtered sulfur containing compounds in the fuel filter; and
releasing filtered sulfur containing compounds stored in the fuel filter into the fuel stream and through the outlet of the fuel filter during predetermined intervals of a regeneration cycle of an emission control device, the predetermined intervals being based upon a volume of fuel passing through the fuel filter.

2. The method of claim 1, wherein release of stored sulfur containing compounds from within the fuel filter and regeneration of the emission control device are synchronized.

3. (canceled)

4. The method of claim 1, wherein the predetermined intervals occur between about every 50 to 100 bed volumes of fuel passing through the fuel filter.

5. The method of claim 1, wherein the predetermined intervals occur between about every 100 to 200 bed volumes of fuel passing through the fuel filter.

6. The method of claim 1, wherein the predetermined intervals occur between about every 200 to 300 bed volumes of fuel passing through the fuel filter.

7. The method of claim 1, wherein the step of filtering sulfur containing compounds from the fuel stream comprises heating a portion of the fuel filter.

8. The method of claim 7, wherein the portion of the fuel filter is heated to at least approximately 160° Celsius.

9. The method of claim 7, wherein the portion of the fuel filter is heated to a steady state temperature for approximately 10 to 20 minutes during each predetermined interval.

10. A system for maintaining optimal performance of an emission control device, the system comprising:
a fuel filter in fluid communication with a fuel line of an internal combustion engine, the fuel filter configured to adsorb sulfur containing compounds traveling through the fuel filter;
an emission control device in fluid communication with an exhaust fluid flow from the internal combustion engine; and
a control device for simultaneously causing discharge of sulfur containing compounds adsorbed within the fuel filter during a regeneration cycle of the emission control device, the discharge of sulfur containing compounds being based upon a volume of fuel flow through the fuel filter.

11. The system of claim 10, wherein discharge of sulfur containing compounds adsorbed within the fuel filter and regeneration of the emission control device is performed between about 50 to 100 bed volume intervals of fuel flow through the fuel filter.

12. The system of claim 10, wherein discharge of sulfur containing compounds adsorbed within the fuel filter and regeneration of the emission control device is performed between about 100 to 200 bed volume intervals of fuel flow through the fuel filter.

13. The system of claim 10, wherein discharge of sulfur containing compounds adsorbed within the fuel filter and regeneration of the emission control device is performed between about 200 to 300 bed volume intervals of fuel flow through the fuel filter.

14. The system of claim 10, wherein the fuel filter includes a heater for heating a portion of the fuel filter to cause discharge of sulfur containing compounds adsorbed within the fuel filter.

15. The system of claim 14, wherein the heater heats the portion of the fuel filter to a steady state temperature of at least about 160° Celsius.

16. The system of claim 15, wherein the heater heats the portion of the fuel filter at a steady state temperature for approximately 10 to 20 minutes.

17. A fuel filter for an internal combustion engine, the fuel filter comprising:
an adsorbent element for capturing sulfur containing compounds flowing through the fuel filter; and
a heating element configured to heat a portion of the fuel filter to cause release of sulfur containing compounds captured by the adsorbent element, the heating element heats the portion of the fuel filter when a predetermined bed volume interval of fuel flows through the fuel filter.

18. The fuel filter of claim 17, wherein the heating element heats a portion of the fuel filter to a steady state temperature between about every 50 to 300 bed volume interval.

19. The fuel filter of claim 18, wherein the heating element heats the portion of the fuel filter at a steady state temperature between about 10 to 20 minutes for each bed volume interval.

20. The fuel filter of claim 19, wherein the heating element heats the portion of the fuel filter to a steady state temperature of about 160° Celsius.
